(19) United States
(12) Patent Application Publication
(10) Pub. No.: US 2010/0297914 A1
(43) Pub. Date: Nov. 25, 2010

(54) LAMINATED ALL ELASTOMERIC FABRIC AND BAR MADE THEREOF

(76) Inventor: Jacky Cheung, Dongguan (CN)

Correspondence Address: WANG & HO, 66 HILLTOP ROAD, MILLINGTON, NJ, 07946, US

(21) Appl. No.: 12/784,843

(22) Filed: May 21, 2010

Related U.S. Application Data
(60) Provisional application No. 61/180,428, filed on May 21, 2009.
(60) Provisional application No. 61/180,886, filed on May 24, 2009.

(51) Int. Cl. A41C 3/00; B32B 5/02

(52) U.S. Cl. 450/65; 428/221

(57) ABSTRACT

A fabric having a memory function, comprising yarns of substantially 100% spandex with a structure of a two-way stretch fabric. The fabric has the “memory” function by which it returns to substantially its original shape after being stretched many times its original size. The fabric can be used to make a laminated fabric in which the memory fabric is sandwiched between a top surface fabric and a bottom surface fabric. The resulting laminated fabric also has the “memory” function and can be used to replace the conventional elastic woven bands used in undergarment in order to increase the elasticity and strength.

### CROSS REFERENCE TO RELATED APPLICATION

This application claims benefit from U.S. Provisional Application No. 61/180,428, filed May 21, 2009 and U.S. Provisional Application No. 61/180,886, filed May 24, 2009. The contents of the two provisional applications are incorporated herein in their entirety.

### FIELD OF THE INVENTION

The present invention relates to the field of fabrics, specifically to elastic woven bands and underwear, particularly to rubber bands and underwear made from the fabric.

### BACKGROUND OF THE INVENTION

Presently, it is known that elastic materials are used for the upper and lower bundles (i.e. flanks) of bras in order to assist the cups in supporting the breasts and keeping them in position relative to the chest circumference. In addition, elastic woven bands are also used for the waists of panties to increase elasticity. In the present market, elastic woven bands are mainly used with two methods. One is to enclose them in cloth through flat seams. The other is to directly attach them to cloth. However, the elastic woven bands have poor elastic resilience and will easily have elastic creep and lose elasticity after being used several times. The elastic woven bands will cause uneven pressure in some parts regardless whether they are enclosed in or attached to the shell fabrics. It is difficult for them to meet the main requirements on flatness, smoothness, softness, close fit, sound elasticity, high level of wearing comfort, etc.

### SUMMARY OF THE INVENTION

An object of the present invention is to provide a fabric having a “memory” function which can be used to replace elastic woven bands to increase the elasticity of and strengthen the support for underwear, and a piece of clothing using the fabric having the above-mentioned “memory” function.

The technical solution used in the present invention is: making a fabric having a “memory” function, comprising a woven main body made of 100% or substantially 100% spandex fabric, and laminating this main body between shall fabrics to provide ready-to-wear cut pieces.

The main body of the fabric having the “memory” function is made by weaving or knitting 100% or substantially 100% spandex material.

Based on the fabric having the “memory” function, the present invention also provides an application using the fabric having the “memory” function to replace the application of the elastic woven bands which are widely used at present.

In the present invention the fabric having the “memory” function is made of 100% or nearly 100% spandex material. Due to the special molecular chain structure of this raw material (see FIG. 3), it provides good elastic resilience and can recover its original shape after stretching by 800%. This means the fabric can easily be stretched but still closely cling to the surfaces of the human body after returning. It has little binding force on the human body, for which it is known as the “secondary skin”. It can be easily elongated by 2 to 5 times it's original length and quickly recover to the original length after the external force is released. It is light and thin, providing good levelness, excellent hand feel, good elastic resilience, and comfortable wear when used to replace the existing ordinary rubber bands. It can be widely applied in the garment industry, especially in the field of underwear such as brassiere, swimwear, briefs, lingerie, etc.

Therefore, the present invention provides a fabric having a memory function, comprising yarns of 100% or substantially 100% spandex with a structure of a two-way stretch fabric.

The present invention further provides a laminated fabric having a memory function, comprising three laminated fabric sheets, being top surface fabric, elastic main body, and bottom surface fabric, wherein said elastic main body is laminated between said top surface fabric and bottom surface fabric and said elastic main body is substantially 100% spandex.

The present invention further provides an undergarment, comprising a piece of the laminated fabric having a memory function as described above.

The various features of novelty which characterize the invention are pointed out with particularity in the claims annexed to an forming a part of the disclosure.

For a better understanding of the invention, its operating advantages, and specific objects attained by its use, reference should be made to the descriptive matter in which there are illustrated and to described preferred embodiments of the invention.

### BRIEF DESCRIPTION OF THE DRAWINGS

FIG. 1 shows the structure of a prior art mesh fabric that is known to be unstable.

FIG. 2 shows the structure of a prior art mesh fabric that is know to be more stable relative to the one shown in FIG. 1.

FIG. 3 shows an exemplary structure of a “memory” fabric according to the present invention.

FIG. 4 is a schematic diagram showing the use of the fabric having a “memory” function in an undergarment as an example.

### DETAILED DESCRIPTION OF PARTICULAR EMBODIMENTS OF THE INVENTION

The detailed fabrication and application of the utility model will be further described with the attached drawing.

In the fabric having the “memory” function described in the present utility model, spandex yarns are woven together with a fine-grade weaving machine. The fabric is then pre-fixed with a Monfoits setting machine in order to stabilize the dimensions of the fabric and prevent deformation of the fabric when it enters the cylinder, as well as the effect of high temperature on the fastness during the subsequent oven-drying process. In addition, the high-temperature pre-fixing can evaporate the silicone oil on the surfaces of the spandex fabric. The pre-fixing temperature shall be higher than 192° C. The pre-fixed fabric is then put into the cylinder for smoking and phenolic yellowing treatment in case it yellows during the subsequent resting process. It is then oven-dried. Since the dimensions have been set during the pre-fixing process, it only has to be oven-dried under a low temperature.

The fabric of the present invention comprises at least three laminated layers where the middle layer is made of substantially all elastomeric fiber (such as Spandex, Lycra, etc) and laminated between two surface layers in a sandwiched manner. The two surfaces can be the same material or different materials, to be chosen according to particular situations. Any materials may be used as long as it can be laminated with the middle elastomeric layer. For example, the upper layer may use any materials suitable for laminating to the elastomeric layer and preferably also providing some pleasant visual effects and the bottom layer, as it is in direct contact with the skin of the wearer, may be any material suitable for laminating to the elastomeric layer and preferably also providing comfortable wear for the wearer.

The laminating process is conventional and known to people having ordinary skill in the art. Therefore, it is not part of the present invention and accordingly not a limitation to the scope of the present invention.

The present invention further provides a method of fabricating bra wings or side panels, which is highly stretchable and able to return to substantially the original shape once the stretching force is removed, that is, that the resulting bra wings or side panels gain a property of having a shape memory. The bra with such wings or side panels provides better support and comfort to the wearer.

Of course, the fabric of the present invention can also be used for fabricating other clothing articles, particularly used for supporting and keeping the shape of a body part of the wearer.

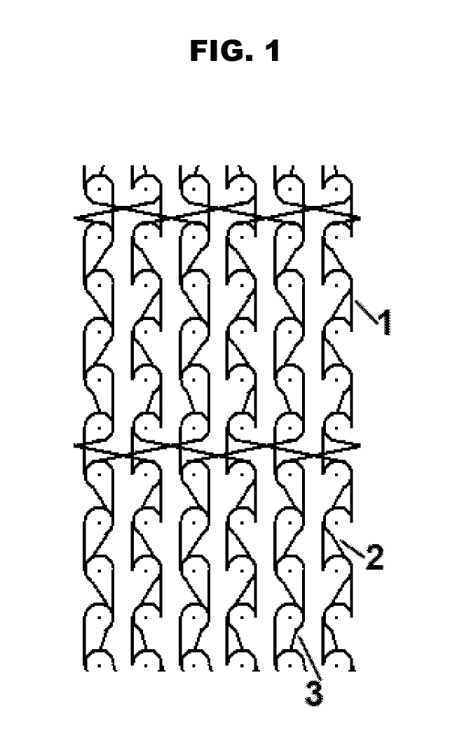

As a comparison, FIG. 1 shows a known method for enhancing the elasticity of fabric by changing the structure of the fabric, which is obtained by the following approaches:

(1) Threading a set of yarns through a front guide bar;

(2) Threading two sets of elastic yarns 2 and 3 through guide bars 2 and 3; and

(3) Operating the machine such that the yarn 1 through the front guide bar 1 forms a pillar stitch, while 2 and 3 are weft insertions, wherein the traversing distance of the weft insertions 2 and 3 and the overall vertical height are adjustable. Since the number of the horizontal connecting lines is quite large, the degree of opening of the fabric is relatively high (see FIG. 1 for details), and the fabric is connected merely through the yarns of the weft insertions, the numbers of the intersection points and the connecting points of the structure are both small, the meshes are unclear and the force borne is very unstable, thus making it easy to rip.

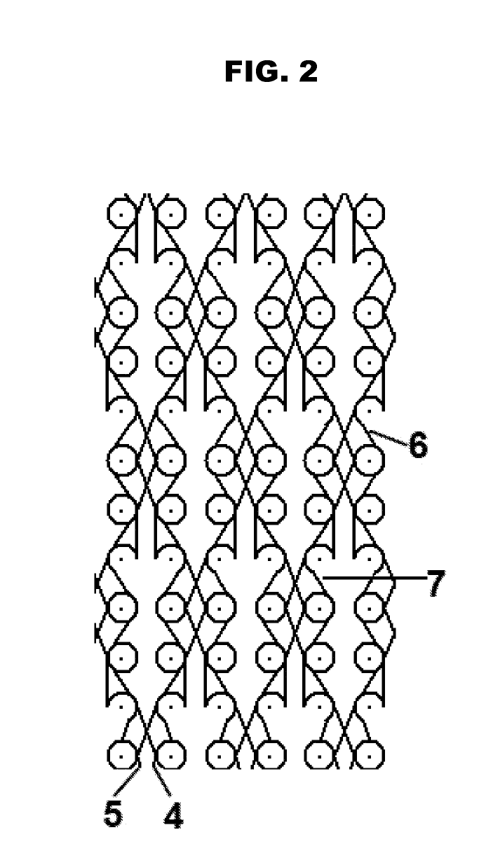

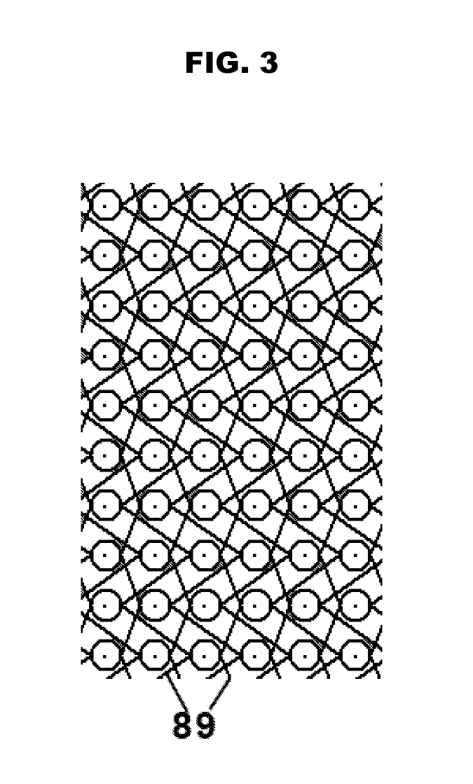

Since the numbers of the intersection points and the connecting points of conventional mesh structure are larger than those of the structure shown in FIG. 1, the force borne on the corresponding fabric is more stable. In a conventional mesh structure shown in FIG. 2, the fabric is formed by four fibers, namely, 3, 4, 5 and 6, and conventionally, 3 and 4 are formed by non-elastic yarns, while 5 and 6 are formed by elastic yarns, and such a combination results in restriction of the fabric in the elastic direction and in elasticity. Therefore, 3, 4, 5, 6 in the structure of the present invention are all formed by elastic yarns. 3 and 4 are knitted into the ground weave of the fabric, i.e. meshes, and 5 and 6 are weft insertions. The elasticity of the mesh fabric is better than that of the mesh fabric shown in FIG. 1. Meanwhile, the tension is more stable than that of the fabric in FIG. 1. However, the fabric of the mesh structure is also easily ripped, and cannot bear much tension. If it is used to cling to a surface, it will be uneven. Therefore, the present invention further provides a two-way stretch plain weave structure, which shown in FIG. 3, to solve the problems and overcome the defects in the production process and during use of the product with a high recovery—95% after stretching or use for many times, and the surface of the finished fabric is flat and exquisite.

Within the meaning of the present invention, the term “two-way stretch fabric” means a fabric of a structure defined in FIG. 3.

The process of producing the fabric comprises the following steps:

(1) Threading a set of elastic spandex yarns through a front guide bar of a warp-knitting machine;

(2) Threading a set of elastic spandex yarns through a back guide bar;

(3) Operating the machine to knit with the front guide bar to form an open or closed cord or satin stitch; and

(4) Operating the machine to knit with the back guide bar to form an open or closed tricot stitch.

100% two-way stretch plain weave spandex fabric is formed by said stitches, and meanwhile, different tensile requirements can be met by adjusting the traversing distance.

The greige cloth produced is preset at a high temperature by a setting machine. The purpose thereof is to stabilize the specification of the fabric and avoid deformation and curling of the fabric. Meanwhile, since there is a large amount of silicone oil on the surface of the spandex, the oil on the fabric surface can vaporize through presetting at a high temperature. The presetting temperature must be above 192 degrees Celsius. The optimal setting effect can be achieved by adjusting parameters such as temperature and speed according to different thickness.

The preset fabric is placed in a vat for fumigation and phenolic yellowing processing so as to prevent unfavorable effect due to yellowing in later storage or use, and is then dried. Since the specification is predetermined in presetting, only a low temperature is required for drying.

Considering that it is difficult for spandex to color and the material is laminated to the inner layer, which is invisible from the outer layer, the material can directly enter the next laminating process without dyeing.

The processed material or cut piece to be laminated is evenly spread on a cutting table, and glue is evenly applied thereon, and then the 100% two-way stretch spandex fabric is firmly bonded between the upper and lower layers of other materials at a high temperature and under a high pressure.

The present invention provides a two-way stretch structure, and is made using 100% spandex material. The degree of opening warpwise and weftwise is adjustable according to the tensile requirements. The fabric surface is flat and has a good elastic recovery.

Average value is obtained through multiple testing using the LTD06 method. Since the mesh fabric is easily ripped, the fabric rips when stretched to 438.07% its original length with a pulling force of 3.3Ibf. With the 100% spandex two-way fabric, due to machine height restrictions, it could only be stretched to 667.3% its original length with a pulling force of 3.3Ibf. during testing. The 100% spandex two-way fabric did not rip when at this machine-maximum test. Therefore, it can be seen from the figure that both the tensile recovery and the stretch length of the 100% spandex two-way stretch fabric are better than those of the ordinary woven elastic tapes. Meanwhile, it is more stable than the fabric of a mesh structure.

Table 1 is a comparison table of tensile recovery between ordinary woven
elastic tapes and the fabric having a “memory” function.

| | Elongation | | | | | |
|---|---|---|---|---|---|---|
| | at 3.3 lbf | Recovery | F | F | F | F |
| | (%) | (%) | (20%)(lbf) | (40%)(lbf) | (60%)(lbf) | (80%)(lbf) |
| Ordinary | 160.8 | 85 | 0.12 | 0.58 | 0.89 | 1.2 |
| woven elastic | | | | | | |
| fabric | | | | | | |
| Ordinary | 188.8 | 92 | 0.099 | 0.303 | 0.438 | 0.559 |
| woven spandex | | | | | | |
| fabric | | | | | | |
| mesh fabric | 438.07 | 99 | 0.002 | 0 | 0.01 | 0.008 |
| with memory | | | | | | |
| Two-way | 667.3 | 99.9 | 0.079 | 0.157 | 0.236 | 0.314 |
| stretch fabric | | | | | | |
| with memory | | | | | | |

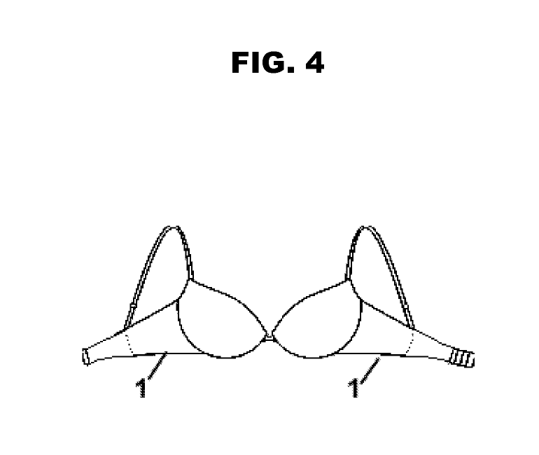

As shown in FIG. 4, the fabric having a “memory” function is adopted, elastic or elastic rubber sheets are originally used between the cups and the back clasp to enhance the strength at the areas referenced by the numeral 1 in FIG. 1, and now a fabric having a “memory” function is adopted in the undergarment such that it has the characteristics of flatness, good recovery, a fashionable appearance, good feel, convenience in use and high level of wearing comfort, etc.

While there have been described and pointed out fundamental novel features of the invention as applied to a preferred embodiment thereof, it will be understood that various omissions and substitutions and changes in the form and details of the embodiment illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention.

What is claimed is:

1. A fabric having a memory function, comprising yarns of 100% or substantially 100% spandex with a structure of a two-way stretch fabric.

2. A laminated fabric having a memory function, comprising three laminated fabric sheets, being top surface fabric, elastic main body, and bottom surface fabric, wherein said elastic main body is laminated between said top surface fabric and bottom surface fabric and said elastic main body is substantially 100% spandex.

3. The laminated fabric of claim 2, wherein said elastic main body has a structure of two-way stretch fabric.

4. An undergarment, comprising a piece of the laminated fabric having a memory function of claim 2.

5. The undergarment of claim 4, which is a brassieres.
